(19) United States
(12) Patent Application Publication
(10) Pub. No.: US 2006/0190992 A1
(43) Pub. Date: Aug. 24, 2006

(54) Facilitating Bi-directional communications between clients in heterogeneous network environments

(75) Inventors: Jiang Li, Beijing (CN); Keman Yu, Beijing (CN); Shipeng Li, Redmond (CN)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/064,928

(22) Filed: Feb. 24, 2005

(51) Int. Cl. H04L 9/32

(52) U.S. Cl. 726/3

(57) ABSTRACT

Techniques for facilitating bi-directional communications between clients in heterogeneous network environments are described. One technique registers a first client from a first network environment and a second client from a second different network environment. Responsive to the first client selecting the second client from a directory of registered clients, the technique forwards data from the first client to the second client and forwards data from the second client to the first client.

### TECHNICAL FIELD

The description relates to techniques for facilitating bi-directional communications between clients in heterogeneous network environments.

### BACKGROUND

The internet has evolved as a conglomeration of multiple interconnected networks. Some of these networks exist in what is loosely termed the public realm. Individual clients in the public realm tend to be more or less permanently associated with a unique identifier to which communications can be sent from other clients. Such a configuration tends to allow efficient two way or bi-directional communications between clients in the public realm. Other networks exist in what is loosely termed as private realms. The private realm networks provide a much more limited communication scenario for an internal client which resides within a private realm network. For instance, a client which exists in a private realm network has limited communication capabilities with an external client which exists in the public realm and/or within another different private network realm. A client which exists within a private realm may not be associated with a unique identifier at which the client can be contacted by an external client and in a sense, under many circumstances, an internal client is essentially invisible to an external client. As used herein a client may be associated with a device and/or a user of the device.

FIG. 1 shows an existing generic heterogeneous network environment 100. The network environment includes a public internet realm 102 and one or more private realms. In this instance, three private realms 104, 106 and 108 are illustrated. Individual private realms are separated from the public realm by some sort of network agent, such as a network address translator (NAT) agent 112, an HTTP (hypertext transfer protocol) proxy server 114, and a firewall 116, respectively.

Various clients or hosts exist in network 100. Clients such as clients 120, 122 exist in the public internet realm 102, clients such as clients 124, 126, and 128 exist within private realms. Clients 120 and 122 each have a globally unique IP (internet protocol) address at which they can be contacted by other clients. For instance, client 120 can initiate communication with client 122 as indicated generally at 130. Client 120 initiates the communication utilizing the unique IP address of client 122. Similarly, client 122 can initiate communications with client 120 as indicated generally at 132 through a globally unique IP address of client 120.

For various reasons network agents tend to prevent clients in their private realm from being ‘visible’ to clients external to that specific private realm. In such a configuration, a client within a private realm may be able to initiate communications with clients in the public realm. In another example, firewalls, for security reasons, tend to block visibility, or access to, clients within their private realm by any clients external to that private realm.

For instance, client 124 can initiate communications with client 120 by communicating with network agent NAT 112 as indicated generally at 134. Network agent NAT 112 then forwards the communication to client 120. However, for various reasons, clients in the public realm generally cannot initiate communications with client in the private realms. For instance, client 120 cannot initiate communications with client 124. Further, clients in one private realm generally cannot initiate communications with clients in other different private realms. For instance, client 124 cannot initiate communications with client 126 or 128 and vice versa.

FIG. 2 illustrates one example of how network agents limit visibility of their client. This example is provided in the context of NAT network agents. In a NAT network configuration, although many nodes are available for clients to access the internal network, there is usually only one single globally unique IP address for outbound connections. All the internal clients are referenced within a private-IP address space which is reserved by the Internet Assigned Numbers Authority (IANA) for private internets. The NAT network configuration provides a mechanism to connect an internal realm with private-IP addresses to an external realm with globally unique registered addresses. However, the inbound connectivity of the internal nodes/clients is lost and the connection is uni-directional.

As evidenced from FIG. 2, a client 124 operating behind NAT network agent 112 can communicate with a client, such as client 120, in the public realm 102. Client 124 initiates communication by sending a UDP packet to client 120 which functions as the responder. The UDP packet is sent via the NAT network agent 112. The packet is first sent from client 124 to NAT network agent 112. The packet is denoted as [IP₁₂₄, P₁₂₄→IP₁₂₀, P₁₂₀], where the IP address and the port number of a hypothetical client X are denoted by IP_{X} and P_{X} respectively. Next, the NAT network agent replaces IP₁₂₄ and P₁₂₄ with its own IP address IP₁₁₂ and available port number P₁₁₂ before forwarding the packet to client 120. When this packet is received by client 120, the client 124 is able to send UDP packets to client 124 by using IP_{112,} and P₁₁₂ as the IP address and port number of the destination. NAT network agent 112 will preserve the mapping of (IP₁₁₂, P₁₁₂) to (IP₁₂₄, P₁₂₄) until the end of the session. Prior to receiving the communication from client 124 via NAT 112, client 120 cannot communicate with client 124 since client 124 does not have a unique identifier which can be accessed by client 120. In essence, client 124 is essentially invisible to client 120 prior to client 124 initiating communications.

The above scenarios provide but a few instances of less than satisfying user experiences for communicating over the internet. Internet users desire capabilities for bi-directional communications with other users regardless of the realm in which either of the user's resides. In one notable instance, users are increasingly seeking bi-directional communications capable of delivering real-time media communication services between the users.

### SUMMARY

Techniques for facilitating bi-directional communications between clients in heterogeneous network environments are described. One technique registers a first client from a first network environment and a second client from a second different network environment. Responsive to the first client selecting the second client from a directory of registered clients, the technique forwards data from the first client to the second client and forwards data from the second client to the first client.

### BRIEF DESCRIPTION OF THE DRAWINGS

FIGS. 1-2 illustrate prior art network configurations.

FIGS. 3-5 illustrate heterogeneous network configurations in which techniques for facilitating bi-directional communications between clients can be implemented.

FIG. 6 illustrates an exemplary process diagram for facilitating bi-directional communications between clients.

FIG. 7 illustrates components of an exemplary communication gateway configured to facilitating bi-directional communications between clients.

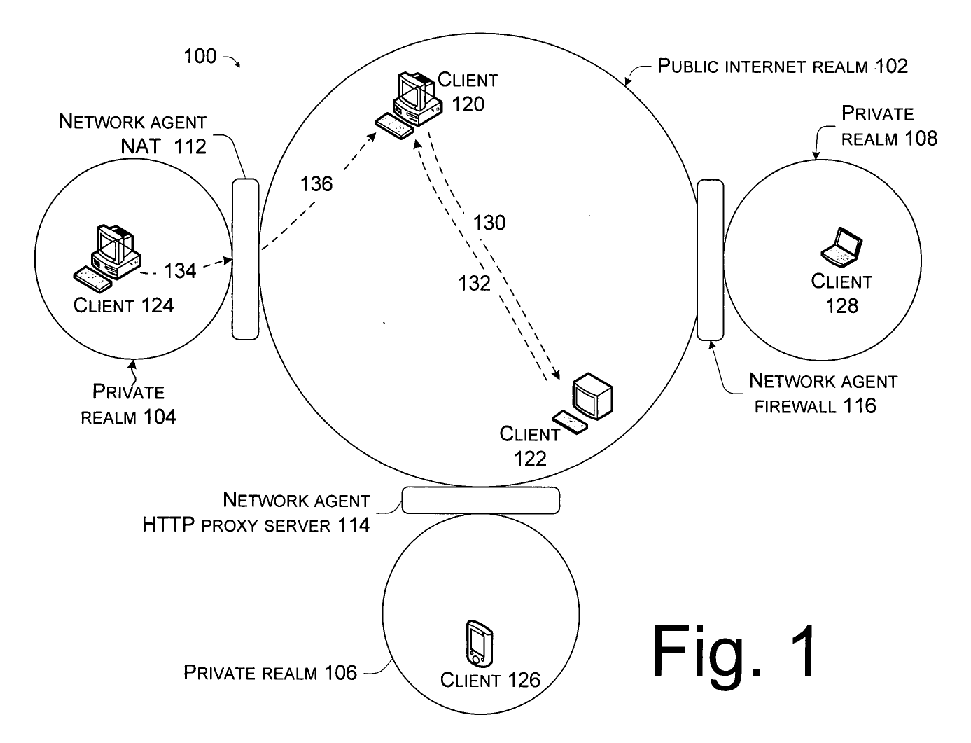

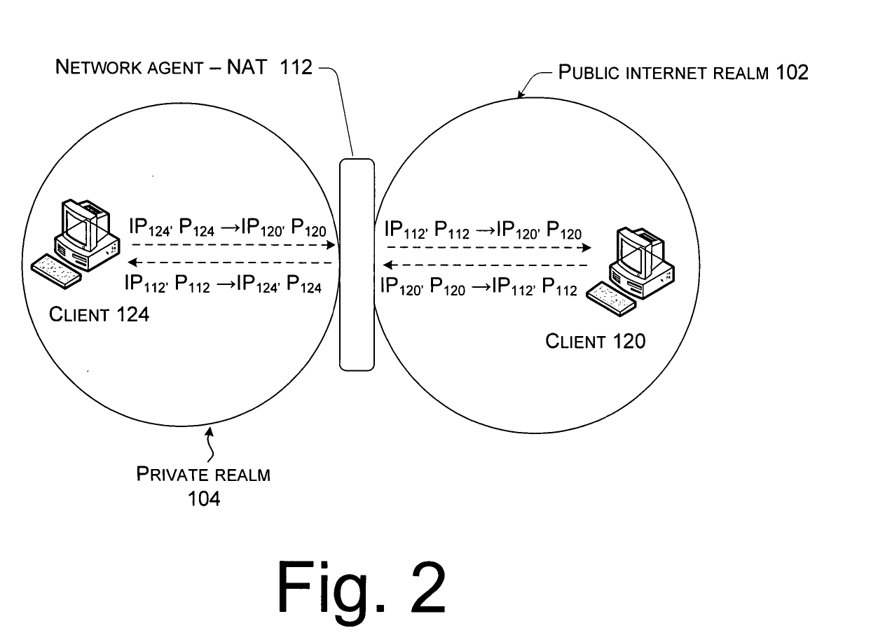

### DETAILED DESCRIPTION

Overview

The following description relates to techniques for facilitating communications, such as multimedia communications, over heterogeneous networks.

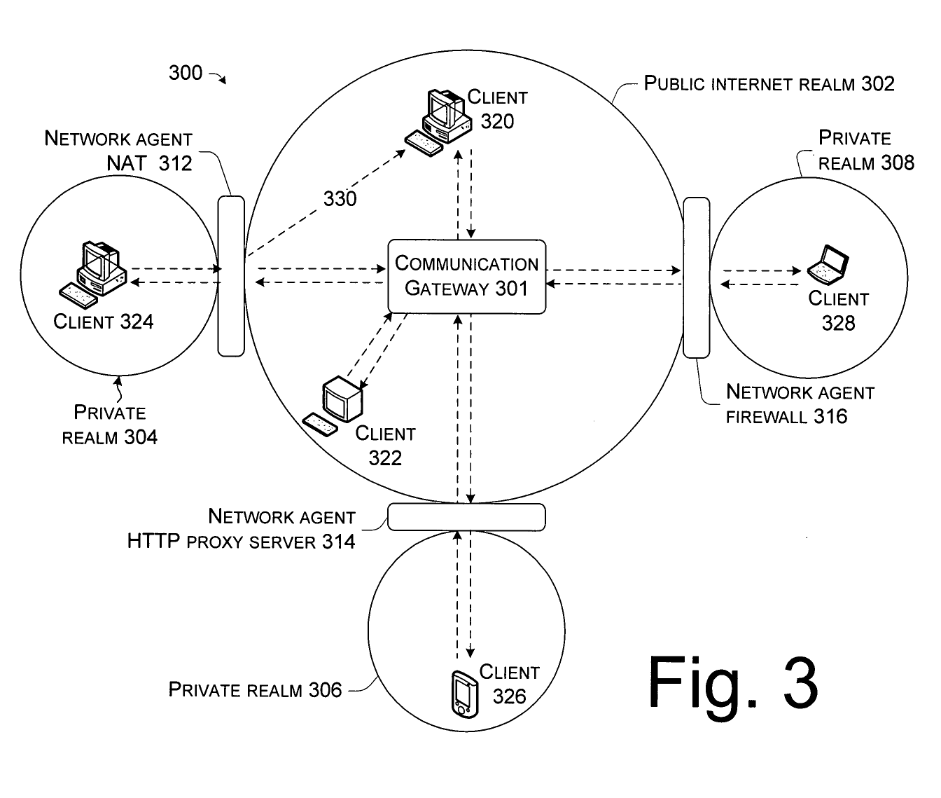

Consider FIG. 3 as an example of a system 300 configured to employ techniques for forwarding communications over heterogeneous networks. System 300 employs a communication gateway 301 for forwarding various messages, such as text, audio and/or video, between clients belonging to different networks. Clients register with the communication gateway utilizing a unique identifier, such as an e-mail addresses.

Communication gateway 301 is employed in public internet realm 302 and facilitates bidirectional communications between a client in the public realm and a client in a private realm and/or between clients which exist in two different private realms. As an example of the former, consider client 320 and client 324. As mentioned above, existing technologies only allow client 324 to initiate communications. In this system configuration, communication gateway 301 allows either of the two clients 320, 324 to initiate communications in a communication session. As an example of a scenario where the clients exist in two different private networks consider client 324 which exists in private realm 304 behind the NAT network agent 312 and client 326 which exists in private realm 306 behind the HTTP proxy server network agent 314. With existing technologies neither client can initiate communications with the other client. The described implementations allow either of the two clients to initiate communications in a communication session.

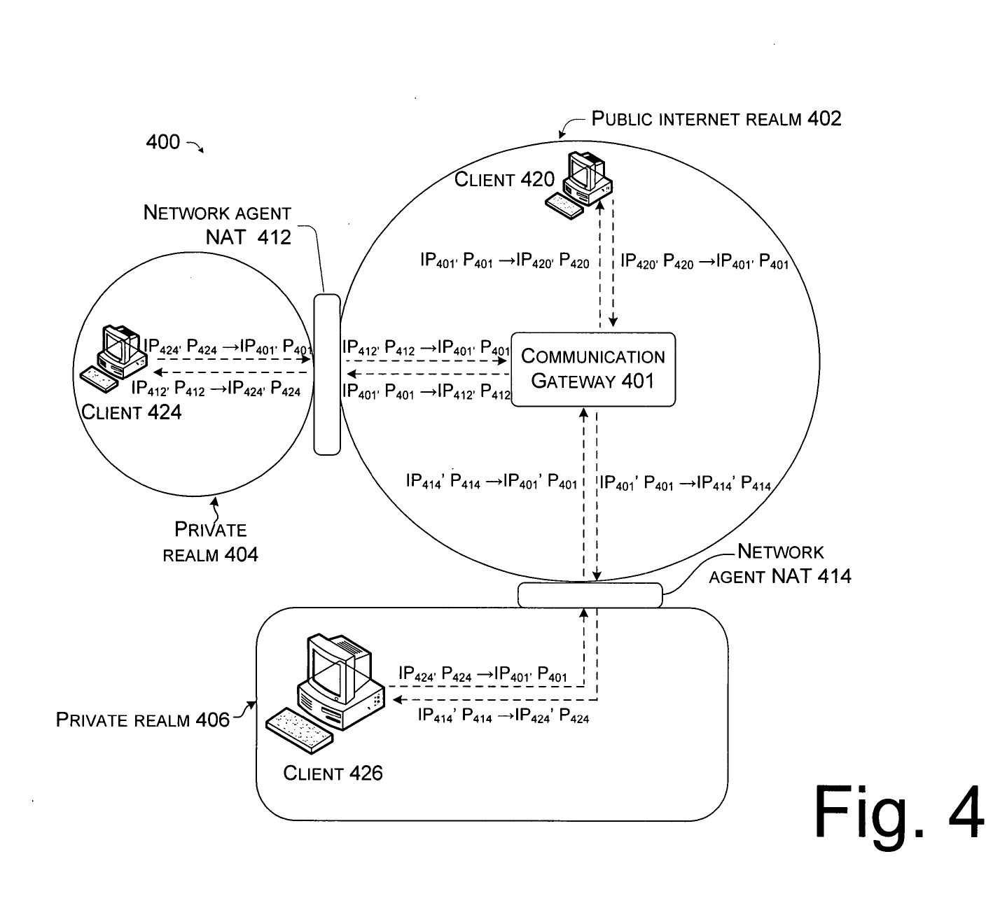

To participate in a communication session facilitated by the communication gateway, a first client registers with the communication gateway with a unique ID, such as an e-mail address. The communication gateway creates a dynamic directory of online users as each user registers. The communication gateway further maps the registered unique ID of each client to the communication path or address utilized by that client to communicate with the communication gateway. An example of this technique is described below in relation to FIG. 4.

The communication gateway 301 may also store some attributes of the clients such as their capabilities of sending audio and video. The communication gateway provides a dynamic directory of online users. From this directory, participating clients can find other clients whether those clients are in the public internet realm or in various private network realms. As will be described below, the communication gateway establishes a channel to forward conference control signals and media streams for each pair of clients wishing to communicate such as via real-time media streaming.

For purposes of explanation assume that the clients 320, 322 which exist in the public internet realm 302, and clients 324, 326, and 328 which exist within private realms 312, 314 and 316 respectively, have all registered with communication gateway 301 and are each listed on the dynamic directory. Communication gateway 301 can facilitate communication between any two or more of the clients. Further, in contrast to the existing art, the communication gateway allows any of the clients to initiate communications with any other client. For instance, assume that client 326 wants to initiate communication with client 328 to engage in bi-directional real-time media streaming such as with a web-cam at each of the two clients. Client 326 selects client 328 from the dynamic directory.

A media stream from client 326 is forwarded to the communication gateway which forwards the media stream to client 328 at its mapped address. Similarly, when client 328 begins to stream media, the media is forwarded by the communication gateway to client 326 at its mapped address. Alternatively or additionally, the communication gateway may provide the address information of each of the two clients to the other of the two clients so that at least some data can be transmitted between the two clients without going through the communication gateway. Such a condition is indicated generally at 330. Further, in instances where the two clients communicate in different formats the communication gateway may provide a translation functionality to allow intercommunication. For instance, the communication gateway might convert UDP (user datagram protocol) data from one client to TCP (transmission control protocol) data for the other client and vice versa. Such an example will be described in more detail below. For ease of explanation, the examples described above and below relate to facilitating communications between first and second clients. The described concepts are equally applicable to larger numbers of clients. For instance, the techniques may be applied to three or more users, such as for conference scenarios among others.

Exemplary Systems and Techniques

Communication with a NAT Client

Consider FIG. 4 as an example of techniques for facilitating communication with a NAT client within a system 400. In this instance, client 424 is a NAT client which exists behind NAT network agent 412 and within private realm 404. Similarly, client 426 exists behind NAT network agent 414 and within private realm 406. In contrast, client 420 exists within public internet realm 402.

Assume for purposes of explanation that client 424 establishes a communication path with communication gateway 401, such as by establishing a TCP connection via NAT network agent 412. In some scenarios the client may also establish additional communications with communication gateway 401. For instance, to participate in media streaming the client may establish one or more UDP connections or sessions with the communication gateway. Upon establishing communications with the communication gateway the client registers a unique identifier with the communication gateway.

In this instance, when a client registers in a communication session and provides a unique identifier, communication gateway 401 maps the unique identifier to the communication path or address utilized by that client to communicate with the communication gateway. For example. for a client in the public internet realm, such as client 420, the registered unique identifier can be the same as the address since the client has a more or less permanent unique IP address. In contrast, for a NAT client such as NAT client 424, the communication gateway may map the registered unique identifier to the NAT network agent's IP address and port number. In one such instance for NAT client 424, the communication gateway 401 maps the client's unique identifier to the session attributes such as the IP address and port number (IP₄₁₂, P₄₁₂) of the session. As long as the session and its communication path remain active between the communication gateway 401 and the client 424 the NAT network agent 412 can forward communications to and from client 424. Accordingly, to maintain access to client 424 the communication gateway and/or client 424 may from time to time take actions to maintain the communication path. For instance, the communication gateway may periodically send packets to the client to keep the session active.

Assume for purposes of explanation that client 426 registers with the communication gateway and selects client 424 via its unique identifier from the dynamic directory. The communication gateway can map from the unique identifier of client 424 to an associated address of client 424. As mentioned above, in this instance, the associated address is to NAT network agent 412 which then forwards the communication to client 424 as long as the session is maintained. The communication gateway can then facilitate communications between client 426 and client 424 by sending data received from client 426 to client 424 and vice versa. As mentioned above, for particular scenarios, the clients may establish additional communication sessions with the communication gateway. For example, for media streaming, each of the clients 424, 426 may establish one or more additional communication paths or sessions. For instance, in one technique for facilitating media streaming each of the clients establishes a UDP path for audio and a second separate UDP path for video. Other variations may be performant in various scenarios.

For purposes of explanation of one implementation, assume that client 426 requests a video conference with client 424. In a configuration where NAT network agents 412, 414 are symmetric NAT network agents, then client 426 can ask the communication gateway to deliver an invitation to client 424. A symmetric NAT network agent is one where all requests from the same internal IP address and port to a specific destination IP address and port, are mapped to the same external IP address and port. Furthermore, only the external client that receives a packet can send a UDP packet back to the internal client. The audio and video streams of the video conference are sent to the communication gateway which forwards them to the other client at the respective NAT network agent's IP address and port number.

In an event that NAT network agents 412, 414 are not symmetric NAT network agents, client 426 can get the respective NAT network agent's IP address and port number of the client 424 from the communication gateway and exchange audio and video streams of the video conference with client 424. Other techniques may utilize more or less pathways and/or formats. In instances where one or the communicating clients is in the public internet realm and posses a unique internet address the communication gateway may facilitate direct communications between the two clients such that less than an entirety of the exchanged data flows through the communication gateway. For instance, if public client 420 requests client 424 from the dynamic directory, the communication gateway may facilitate communications by providing the address of client 420 to client 424. In such a scenario, data from client 420 is sent to the communication gateway which forwards the data to NAT client 424. Data from NAT client 420 may be directed to client 420 directly rather than through the communication gateway.

Communication with an HTTP Client

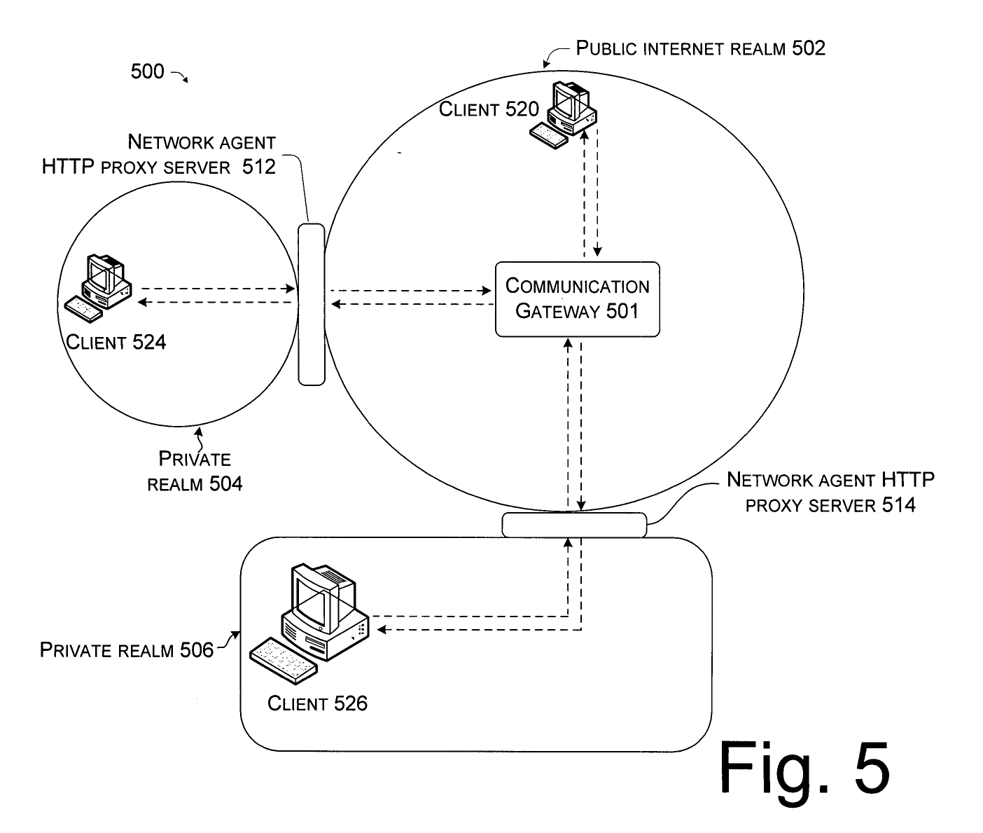

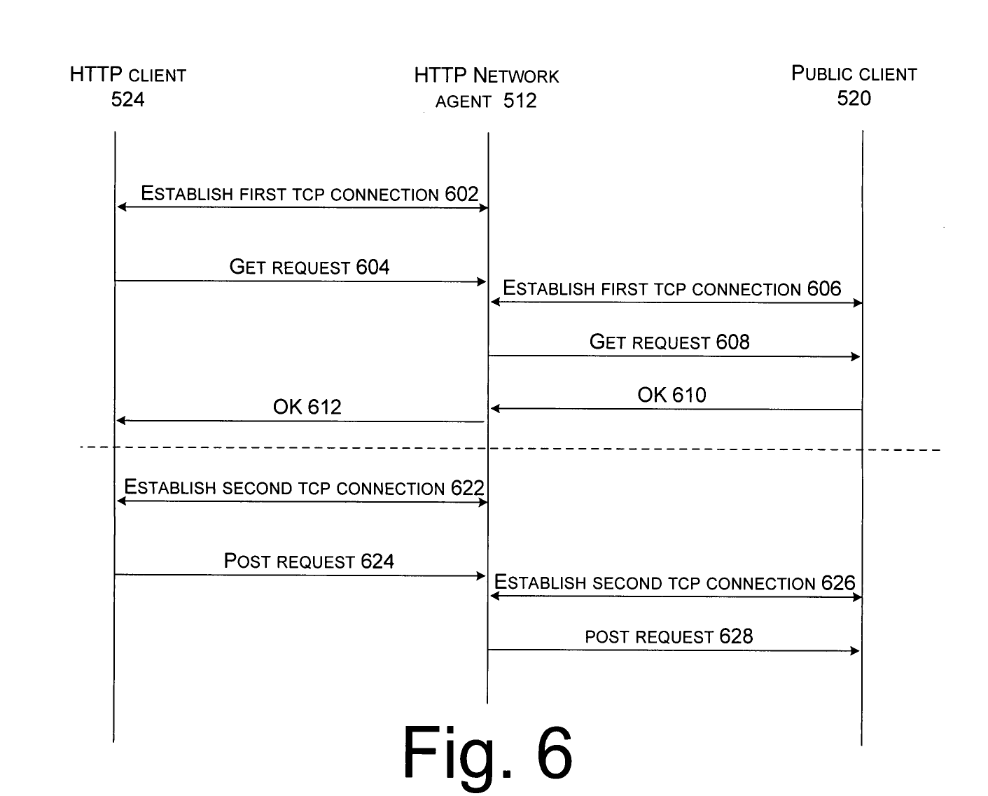

Consider FIGS. 5-6 as examples of techniques for facilitating communication with an HTTP client. In this instance, client 520 exists in public internet realm 502. Client 524 is an HTTP client which exists behind HTTP network agent 512 and within private realm 504. Similarly, client 526 exists behind HTTP network agent 514 and within private realm 506. For HTTP clients, at least some implementations utilize two HTTP connections to establish their outbound and inbound transmissions.

Consider FIG. 6 which illustrates one such technique for enabling continuous bi-directional traffic between an HTTP client and a public client using two HTTP connections. In this instance, FIG. 6 is described in the context of establishing bi-directional communications between an HTTP client and a public realm client. For instance between client 524 and client 520 as described in relation to FIG. 5. This technique can also be applied to establishing bi-directional communications between two HTTP clients as will be described in more detail below.

This particular technique enables continuous bi-directional traffic between an HTTP client such as client 524 and a public client, such as client 520. The technique establishes a first TCP connection between HTTP client 524 and HTTP network agent 512 generally at 602. The HTTP client 524 sends a “GET” request at 604. The GET request contains the IP address and port number of public client 520. At 606, the HTTP network agent 512 establishes a first TCP connection with the public client. Once the connection is established, the HTTP network agent 512 connects to the public client 520 and delivers the “GET” request to the client at 608. At 610, an “OK” message returns from the public client 520 once the request is accepted. The OK message will be delivered to the HTTP client 524 through the HTTP network agent at 612.

The technique described in relation to acts 602-612 establishes a channel for the public client 520 to transmit data to the private HTTP client 524. In order to transmit data from the private HTTP client 524 to the public client 520, the private HTTP client establishes a second connection to the HTTP network agent at 622. The HTTP client then issues a “POST” request at 624. The HTTP network agent 512 then establishes a connection to the public client 520 at 626. Once the connection is established, the HTTP network agent connects to the public client 520 and delivers the “POST” request to the public client at 628. Hence, the HTTP client can use the second connection to send continuous data to the public client.

In this implementation, the format of “GET” and “POST” headers are defined below. The “Keep-alive” property is used to maintain the connection between the HTTP network agent and the clients; the parameter “no-cache” indicates that the response message should not be cached anywhere. The “Content-length” field should be assigned a relatively large number so that the channel can carry continuous media streams without sending any more HTTP headers.
GET/POST http://IP-address:port HTTP/1.1
Connection: Keep-alive
Accept: */*
Cache-Control: no-cache
Content-length: xxxxxxxx (only in POST command)
The format of “OK” command is defined as follows:
HTTP 200 OK
Content-type: application/binary
Content-length: xxxxxxxx

The above described techniques enable bi-directional communication between an HTTP client and a public client. These techniques are equally applicable to other types of clients. For instance, the communication gateway may act as the public client to establish bidirectional communication with the HTTP client. The communication gateway then facilitates bi-directional communication between the HTTP client and a selected client consistent with the techniques described above and below. In another example, if the participants are two HTTP clients, a technique similar to that described in relation to FIG. 4 for two NAT clients can be utilized. The two HTTP clients logon to the communication gateway with their respective unique IDs. Both HTTP clients establish two TCP connections to the communication gateway using the aforementioned technique. Conference control signals and media streams can then be transmitted between the two HTTP clients via the communication gateway and the two HTTP network agents.

Since the “GET” and “POST” requests are sent asynchronously, it is possible that multiple requests arrive at the communication gateway at the same time. To correctly associate the pair of “POST” and “GET” requests, the technique uses the client's unique identifier which in this instance is their respective e-mail address as their identification. The format is as follows.
GET/POST http://IP-address:port/email-address HTTP/1.1
   Communication Between a NAT Host and an HTTP Host

In many instances real-time multimedia applications employ the UDP protocol to transmit media data. In most multimedia streaming situations, TCP is not used because TCP contains strict TCP congestion controls. The TCP congestion controls may cause sharp changes in the sending rate within a communication session. Alternatively or additionally the TCP congestion controls may result in unnecessary retransmission of lost packets. The techniques described above tend to utilize UDP, where practical, in communications between a NAT client and a public client, and/or between two NAT clients. However, TCP may be the only protocol available for HTTP clients. The communication gateway can facilitate bi-directional communications between an HTTP client and another client, such as a NAT client by translating UDP packets to TCP packets and vice versa to allow communications between the two clients. Such techniques can be especially performant in facilitating real-time audio/video streaming between an HTTP client and a NAT client.

Exemplary Communication Gateway Configuration

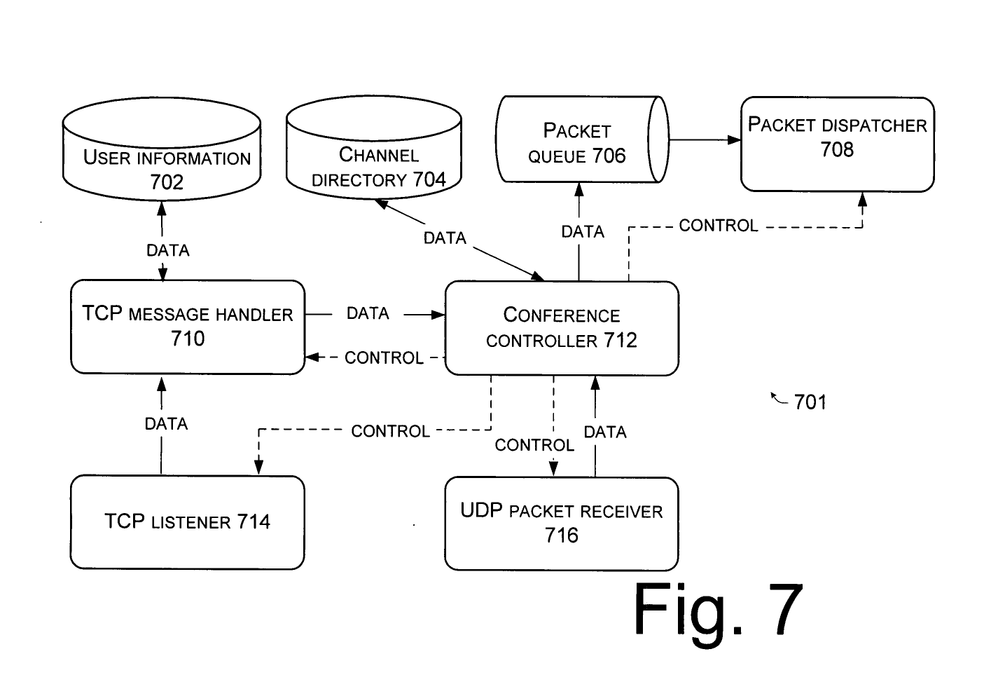

FIG. 7 shows several components of the communication gateway 701 and the interactions of these components consistent with at least some implementations for facilitating bi-directional communications. In this configuration the communication gateway supports control signal delivery, media stream forwarding, and/or client directory management to facilitate bi-directional communications between clients. In this configuration, communication gateway 701 includes a user information component 702, a channel directory component 704, a packet queue component 706, a packet dispatcher component 708, a TCP message handler component 710, a conference controller component 712, a TCP listener component 714, and a UDP packet receiver component 716.

In this implementation, the TCP listener 714 listens to connecting requests and receives TCP data. The control messages are carried in TCP protocol. TCP message handler 710 is responsible for TCP packet parsing and dispatching. The operations of user registration and directory querying are performed in this component and the results are delivered to the conference controller 712.

For NAT clients and public clients, media data are encapsulated in UDP datagrams and handled by the UDP packet receiver 716. However, media streams can also be transmitted in TCP protocol, such as for HTTP-clients. Once a media packet is received, conference controller 712 parses the source and destination addresses, which are represented by e-mail addresses in one solution. The conference controller 712 creates a forwarding channel if appropriate. Forwarding channels are used to rapidly locate the correct receiver. Finally, the media packet and the receiver's information are placed into the packet queue 706. A thread called packet dispatcher 708 continuously takes messages from the packet queue 706 and forwards the messages to the recipient. In some implementations, if the recipient is an HTTP client, a TCP connection is used; otherwise, UDP protocol is employed.

The channel directory 704 serves to improve the forwarding efficiency of the communication gateway. In some configurations the channel directory employs an RB-tree (Red-Black Tree) structure to store channel entries. Two RB-trees are employed for TCP channels and UDP channels respectively. Each channel entry is composed of two pointers that link to the sending client and the receiving client in the storage of the user information 702. The TCP channel is mapped by the connection handle of the sender, whereas the UDP channel is mapped by the combination of the sender's IP address, and the port number. Consequently, the communication gateway 701 can rapidly locate the corresponding recipient client from the channel directory 704, rather than exhaustively search the entire user information storage.

Although embodiments relating to techniques for facilitating bi-directional communications between clients in heterogeneous network environments have been described in language specific to structural features and/or methods, it is to be understood that the subject of the appended claims is not necessarily limited to the specific features or methods described. Rather, the specific features and methods are disclosed as exemplary implementations for facilitating bi-directional communications between clients in heterogeneous network environments.

1. A media streaming method, comprising:
registering a first client from a first network environment and a second client from a second different network environment; and,
responsive to the first client selecting the second client from a directory of registered clients, forwarding data from the first client to the second client and forwarding data from the second client to the first client.

2. A media streaming method as recited in claim 1, wherein the registering comprises registering a unique identifier associated with an individual client and mapping the unique identifier to a communication path of the individual client.

3. A media streaming method as recited in claim 2 further comprising taking an action to maintain the communication path of an individual client.

4. A media streaming method as recited in claim 3, wherein the taking an action comprises periodically sending a packet over the communication path.

5. A media streaming method as recited in claim 1, wherein the first client is configured to handle a first data format and the second client is configured to handle a second data format and further comprising translating data from the first client into the second data format before forwarding the data to the second client and translating data from the second client into the first data format before forwarding the data to the first client.

6. A media streaming method as recited in claim 1, wherein in the event that the first client exists within a NAT network, said act of registering comprises registering an IP address and port numbers of a NAT network agent through which the first client is communicating.

7. A media streaming method as recited in claim 1, wherein in the event that the first client exists within an HTTP network, said act of registering comprises establishing two connections to the first client through an HTTP proxy server network agent.

8. A media streaming method as recited in claim 1, wherein at least one of the first network environment and the second network environment is a private realm network environment.

9. One or more computer-readable media having computer-readable instructions which, when executed, implement the media streaming method of claim 1.

10. A computing device configured to implement the media streaming method of claim 1.

11. A method, comprising:
establishing a first TCP connection between an HTTP client and an HTTP proxy server;
sending a get request over the first TCP connection, the get request containing an address and port number of a selected client;
establishing a second TCP connection between the HTTP client and the HTTP proxy server; and,
sending a post request over the second TCP connection, the post request relating to the address and port number of the selected client.

12. A method as recited in claim 11, wherein the acts of establishing a second TCP connection and sending a post occur responsive to receiving a message indicating that the get request has been accepted.

13. A method as recited in claim 11, further comprising:
receiving a different get request from the selected client;
accepting the different get request; and,
sending a message indicating that the different get requested has been accepted.

14. One or more computer-readable media having computer-readable instructions which, when executed, implement the method of claim 11.

15. A computing device configured to implement the method of claim 11.

16. A system, comprising:
means for registering a first unique identifier associated with a first client from a first network environment and a second unique identifier associated with a second client from a second different network environment;
means for mapping the first unique identifier to a communication path of the first client and the second unique identifier to a communication path of the second client;
means for forwarding communications from the first client to the communication path of the second client and from the second client to the communication path of the first client.

17. A system as recited in claim 16, wherein the first network environment comprises one of: a NAT private network, an HTTP private network, and a private network realm existing behind a firewall.

18. A system as recited in claim 16, wherein the first network environment comprises one of: a NAT private network, an HTTP private network, and a private network realm existing behind a firewall, and the second different network comprises one of: a different NAT private network, a different HTTP private network, and a different private network realm existing behind a firewall.

19. A system as recited in claim 16, further comprising means for maintaining the first and second communication paths.

20. A system as recited in claim 16 embodied as a computing device.
